(19) United States
(12) Patent Application Publication
(10) Pub. No.: US 2009/0164264 A1
(43) Pub. Date: Jun. 25, 2009

(54) Method Of Communicating The Carbon Footprint For A Particular Product To Consumers

(75) Inventor: Anthony J. Zolezzi, Los Angeles, CA (US)

Correspondence Address: Crockett & Crockett, Suite 400, 24012 Calle De La Plata, Laguna Hills, CA, 92653, US

(73) Assignee: Luberski, Inc.

(21) Appl. No.: 11/960,573

(22) Filed: Dec. 19, 2007

(51) Int. Cl. G06Q 10/00

(52) U.S. Cl. 705/7

(57) ABSTRACT

A method of communication the carbon footprint of a product to consumers.

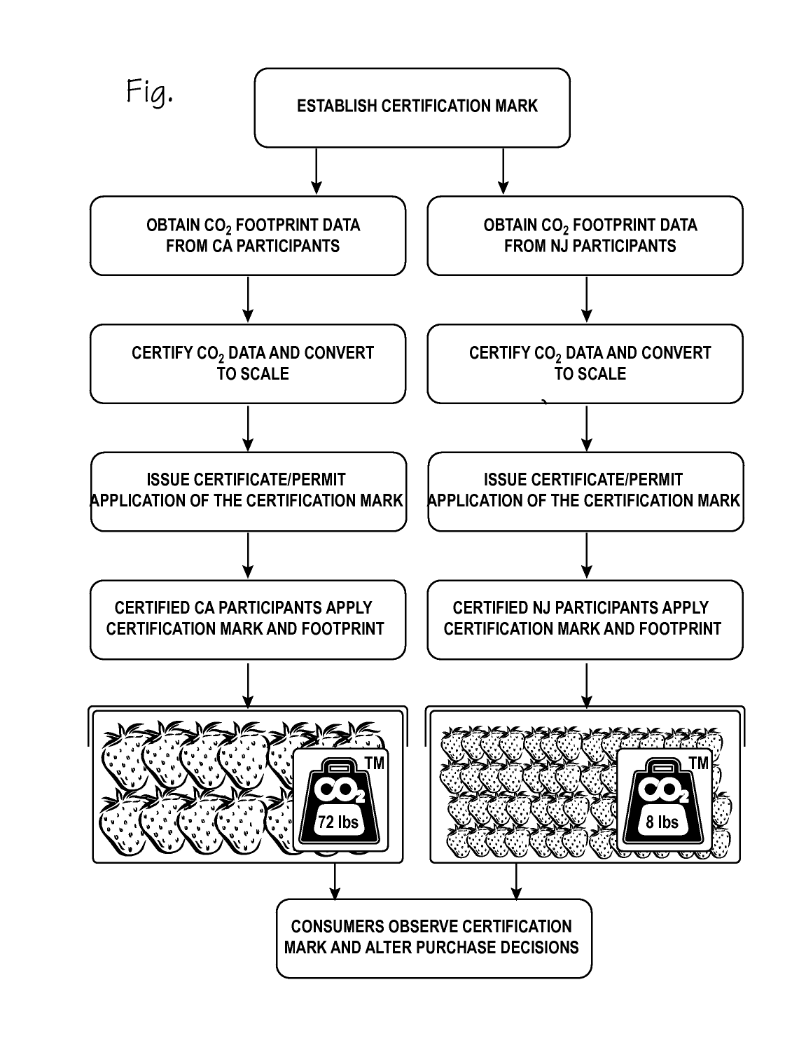

### FIELD OF THE INVENTION

The inventions described below relate the new field of carbon footprint certification.

### BACKGROUND OF THE INVENTION

With the growing concern over global warming, consumers may be interested to know that common groceries, household products and consumer goods result in contributions to greenhouse gas emissions by virtue the various processes used to grow or make them, distribute them and/or dispose of them. Once given accurate information regarding the amount of greenhouse gases created in the life cycle of a given product, consumers may choose products with small carbon footprints vis-à-vis competitive products. To the extent that consumers are concerned about global warming, and willing to consider carbon footprints in purchasing decisions, producers will be encouraged to reduce the carbon footprint of their products. Thus, by providing accurate information regarding the carbon footprint of various products, a certifying organization can promote a reduction of greenhouse gas emissions through free market behaviors of consumers and free market responses by producers.

However, the carbon footprint of a product may be subject to vague descriptions by producers, or technically accurate but misleading statements by producers. For example, consumers are currently being educated to understand that locally grown foods require less CO₂ emissions because they are not flown or trucked to their local markets from distant farms. This may be generally true, but the farming practices, including fertilization, mechanization, preservation and refrigeration may greatly increase the carbon footprint of produce from one producer relative to competitors (a local producer employing organic farming practices can waste it's carbon savings if it uses old grossly polluting diesel tractors and burns its crop residue in open fields, as is done in sugar production). In another example, consumers are likely totally ignorant of the carbon footprint of different types of clothing. Cotton clothing assembled in far-away countries from cotton grown with heavy fertilizer use may have a very large carbon footprint compared with locally made woolen goods. The carbon footprints of such products cannot be reasonably estimated by consumers, and claims of manufacturers are not likely to be universally credible. Thus, a certification system which provides trustworthy and accurate information regarding the carbon footprint of products would benefit those consumers willing to choose one product over another based on knowledge of the carbon footprints of each.

### SUMMARY

The carbon footprint certification and method describe below provides a mechanism for communicating the carbon footprint of products, at the point of sale, to consumers and also communicating to consumers the trustworthiness of the information provided. The method entails establishing a certification mark indicative of the source of the certification and applying the certification mark to numerous products in a manner which is readily visible at the point of sale. The method also entails establishment or adoption of a scale useful for indication the absolute or relative carbon footprint of each product, preferably close to the certification mark. To establish the certification mark, consumers are educated as to the image of the mark, the meaning of the mark, and the products on which they might expect to see it. To establish or adapt the carbon footprint scale, the method may use an absolute scale, such as pounds of CO₂ emissions per product or unit of product, or a relative and arbitrary scale, such as a scale of 1 to 10, or grades like A through F, with one extreme indicating the lowest possible or lowest practical carbon footprint or lowest actual footprint in an industry segment, and the other extreme indicating very high carbon footprints, or the worst actual footprint in an industry segment. To grade products, the various factors are considered, as described below.

### BRIEF DESCRIPTION OF THE DRAWINGS

The FIGURE is a flow chart illustrating the method.

### DETAILED DESCRIPTION OF THE INVENTION

The method is illustrated briefly in the FIGURE, which is a flow chart illustrating the method. The certifying organization establishes the mark through adoption and use of the mark. Establishment may be augmented with advertisements and widespread consumer education regarding the identity and purpose of the mark. The certifying organizing obtains CO₂ footprint data from producers, distributors and retailers pertaining to as many aspects of production, distribution and sale as is practical. In this case, the certifying organization obtains data from two different participants that will distribute in New Jersey: A strawberry producer in California and a strawberry producer in New Jersey. The certifying organization certifies the correctness of the data and converts to that data to a scale. In this case, the scale is an absolute scale of pound of CO₂ produced per unit of product. After certification, the certifying organization communicates to the participants that they may apply the certification mark, and also specifies the indicia that they may provide as an indication of value for the CO₂ footprint of their respective products. The participants apply the certification mark and the certified and specified CO₂ footprint value to the product in a manner that is visible to the consumer at the point of sale. In this example, the product is a small container of strawberries, and the certifying organization has calculated that each quart results in emission of 72 pounds of CO₂ for the California producer and 8 pounds of CO₂ for the New Jersey producer, for products distributed in New Jersey. The certifying organization communicates to the participants that they are permitted to display this data on the product. The participants apply the certification mark, and their respective specified and certified CO₂ footprint data, on the packaging for strawberries. Consumers may then purchase the strawberries, and their choice may be informed by the CO₂ footprint of each product. Environmentally conscious consumers may decide to purchase the New Jersey strawberries over the California strawberries, based in some instances on the carbon footprint. Thus, by perfecting the free market assumption of abundant information, in a population that may use environmental information in purchasing decisions, significant free market forces can be brought to bear to encourage, by increasing demand, the production of products with lower CO₂ emissions vis-à-vis competitive products.

Certification of the data may be accomplished by independent audits of the participants, independent calculations and testing, or by determining the trustworthiness of the participants providing the data.

To calculate the carbon footprint of a product, energy inputs, carbon emissive by products, carbon emissive constituents, fuel and power consumption, transportation and storage energy consumption, and any other relevant factors are included. For groceries, clothing, and other products based on agriculture, the following factors may be incorporated into a carbon footprint rating:
Emissions for Production: fuel for farm equipment, fertilizer and/or feed, emissions or consumption during growth, ambient temperature control, water pumping, crop residue disposition, silage, acreage production, etc.
Emissions for Distribution: Packaging footprint, length of transport, temperature control during transport, temperature control at the point of sale, etc.
Emissions for Consumption: fuel expected to be consumed in cooking.
Emissions for Disposal: Fuel consumption for trash disposal, incineration, landfill decomposition, etc.

Each of these sources of greenhouse gas emission are calculated to the extent that the data can be obtained. The information regarding each particular source of emissions can be obtained from the producers and distributors involved, or may be calculated from detailed records of fuel use, fertilizer use, equipment specifications, and production methods, or example, by the operator of the certifying organization. Information regarding some particulars, such as emissions for distribution, can be estimated (for example, the estimated CO₂ emissions associated with flying produce from remote farms to local groceries). The CO₂ emissions associated with consumption and disposal of waste may be estimated by the certifying organization or determined by testing of typically used processes. The certifying organization can submit questionnaires to producers, distributors and retailers, and even some consumers, to obtain the necessary information.

The parameters used to determine the CO₂ emission of any step may include the quantities of fuel used in each of the processes, the quantities of chemicals, fertilizers, cleansers, etc used in each process. The data obtained is used to calculate the resultant CO₂ emissions. For example, the CO₂ emissions resulting from a farming operations can be calculated based on the reported consumption of fuel and fertilizer and water per acre and the yield per acre, and this can be calculated to determine pounds of CO₂ per unit (bushel, pound, quart, etc. of produce) and included in the total carbon footprint rating. Upon determination of to total CO₂ footprint, the certifying organization may issue, or permit the producer to create, certification labels indicating the total CO₂ footprint of the product. If absolute values cannot be obtained, the CO₂ footprint can be represented by an arbitrary scale. For example, locally grown produce which is also grown with little fertilizer and modern low-emission farm equipment, and which requires not refrigeration in transit or storage, might be assigned an arbitrary score of 10, while produce grown far away, with heavy fertilizer use and old farm equipment might be assigned an arbitrary score of 1, with variations in these and other factors leading to scores intermediate between the best and worst score.

The task of the certifying organization is to ensure determine the CO₂ footprint of products and permit producers to visually indicate the footprint, along with a certification mark indicating the trustworthiness of the indicated footprint, on packaging, or point of sale displays, or on the products themselves. The certifying organization may collect fees, including royalties, to cover the cost of CO₂ footprint determination and public education regarding the purpose and intended use of the certification. Thereafter, the producer, distributor or retailer of the product will apply the certification mark and the footprint value, to the product.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method of communicating the carbon footprint of a product to consumers, said method comprising the steps of:
establishing a certification mark for indicating to consumers that a product has been analyzed for carbon footprint;
establishing a rating method for analyzing a product for carbon footprint, said rating method comprising the steps of:
establishing a rating scale corresponding to a range of potential carbon footprint values of a product;
obtaining data from producers, distributors, and retailers regarding the carbon footprint associated with the product;
converting the data to a rating relating the carbon compound released by the production, distribution, and retail sale of the product to a rating scale
marking the product with a certification mark and the carbon footprint rating in a manner visible to consumers at the point of purchase.

2. The method of claim 1 further comprising the steps of:
determining the carbon footprint by summing the CO₂ emissions arising form production, distribution and sale of a product, and converting this data to an absolute rating.

3. The method of claim 1 further comprising the steps of:
determining the carbon footprint by summing the CO₂ emissions arising form production, distribution and sale of a product, and converting this data to a relative rating, said relative rating being established by comparison with the carbon footprint of competitive products.

4. A method of communication the carbon footprint of a product to consumers, said method comprising the steps of:
establishing a certification mark for indicating to consumers that a product has been analyzed for carbon footprint;
establishing a rating method for analyzing a product for carbon footprint, said rating method comprising the steps of:
establishing a rating scale corresponding to a range of potential carbon footprint values of a product;
obtaining data from third parties who produce the product regarding the carbon footprint associated with the product;
converting the data to a rating relating the carbon compound released by the production, distribution, and retail sale of the product to a rating scale
licensing third parties who make the product to mark the product with a certification mark and the carbon footprint rating in a manner visible to consumers at the point of purchase.

5. The method of claim 4 further comprising the steps of:
determining the carbon footprint by summing the CO₂ emissions arising form production, distribution and sale of a product, and converting this data to an absolute rating.

6. The method of claim 4 further comprising the steps of:
determining the carbon footprint by summing the CO₂ emissions arising form production, distribution and sale of a product, and converting this data to a relative rating, said relative rating being established by comparison with the carbon footprint of competitive products.
